(19) United States
(12) Patent Application Publication
(10) Pub. No.: US 2011/0132543 A1
(43) Pub. Date: Jun. 9, 2011

(54) BRUSH TYPE PLASMA SURFACE TREATMENT APPARATUS

(75) Inventor: Han Young YU, Daejeon (KR)

(73) Assignee: ELECTRONICS AND TELECOMMUNICATIONS RESEARCH INSTITUTE, Daejeon (KR)

(21) Appl. No.: 12/949,512

(22) Filed: Nov. 18, 2010

(30) Foreign Application Priority Data
Dec. 9, 2009 (KR) 10-2009-0121579
Jul. 6, 2010 (KR) 10-2010-0064712

(51) Int. Cl. H05H 1/24

(52) U.S. Cl. 156/345.35

(57) ABSTRACT

A brush type plasma surface treatment apparatus is provided. The brush type plasma surface treatment apparatus includes a frame for plasma generation units, a plurality of plasma generation units arranged in an array at the lower edge of the frame, a gas supply hole installed on one side of an upper edge of the frame and supplying a gas to the plurality of plasma generation units, and a power supply unit installed on the other side of the upper edge of the frame and supplying power to the plurality of plasma generation units.

### CROSS-REFERENCE TO RELATED APPLICATION

This application claims priority to and the benefit of Korean Patent Application Nos. 10-2009-0121579, filed Dec. 9, 2009 and 10-2010-0064712 filed Jul. 6, 2010, the disclosure of which is incorporated herein by reference in its entirety.

### BACKGROUND

1. Field of the Invention

The present invention relates to a brush type plasma surface treatment apparatus, and more particularly to a brush type plasma surface treatment apparatus having a plurality of plasma generation units arranged in an array.

2. Discussion of Related Art

In general, methods of treating the surface of an object include chemical reaction treatments using chemicals, electrochemical treatments, physical treatments, and so on. Among these methods, chemical treatments have a drawback of generating chemical pollutants, and physical treatments have a drawback of low efficiency.

In a physical treatment, a brush may be used to physically treat the surface of an object. Here, the brush serves only to brush the surface of an object. Thus, constant maintenance is required to remove foreign substances or keep the surface clean. Also, in a conventional physical surface treatment, it is difficult to deposit an additional substance.

During research on an apparatus for treating the surface of an object, that is, a method of combining a physical treatment technique with a chemical treatment technique, the present inventors found that the surface of an object can be treated physically and chemically by a brush type plasma surface treatment apparatus having a plurality of plasma generation units arranged in an array, and thereby designed the present invention.

### SUMMARY OF THE INVENTION

The present invention is directed to a brush type plasma surface treatment apparatus having a plurality of plasma generation units which are arranged in an array and can treat the surface of an object physically and chemically.

One aspect of the present invention provides a brush type plasma surface treatment apparatus including: a frame for plasma generation units; a plurality of plasma generation units arranged in an array at a lower edge of the frame; a gas supply hole installed on one side of an upper edge of the frame, and supplying a gas to the plasma generation units; and a power supply unit installed on the other side of the upper edge of the frame, and supplying power to the plurality of plasma generation units.

In the brush type plasma surface treatment apparatus, the plasma generation units may have a nozzle shape or a needle shape, the power supply unit may supply the power from an external direct current (DC) power supply or alternating current (AC) power supply to the respective plasma generation units, and a variable resistor may be attached to each of the plasma generation units to adjust plasma generation power and uniformly generate plasma.

Also, in the brush type plasma surface treatment apparatus, the frame for plasma generation units may include an auxiliary frame connected to the frame to space the respective plasma generation units apart from a surface and support the plasma generation units.

Further, the brush type plasma surface treatment apparatus may further include at least one controller capable of controlling the plasma generation units to spray plasma.

In the brush type plasma surface treatment apparatus, each of the plasma generation units may include: a first electrode for supplying the power; a plasma chamber containing the first electrode; a supply path for a gas for plasma generation and reaction between the first electrode and the plasma chamber; a second electrode attached to the outside of the plasma chamber and supplying the power; and a slit-shaped spray hole for spraying plasma generated in the plasma chamber to the outside.

The plasma generation units may further include an insulating layer on the first electrode, and also an adjustment gas chamber for introducing an adjustment gas for adjusting the plasma.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a schematic perspective view of a plasma surface treatment apparatus according to an exemplary embodiment of the present invention;

FIG. 2A is a cross-sectional view of a plasma generation unit according to an exemplary embodiment of the present invention;

FIG. 2B is a cross-sectional view of a plasma generation unit according to another exemplary embodiment of the present invention; and

FIG. 3 illustrates a plasma surface treatment apparatus according to an exemplary embodiment of the present invention used to treat the surface of a dye-sensitized solar cell (DSSC) before dye absorption.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

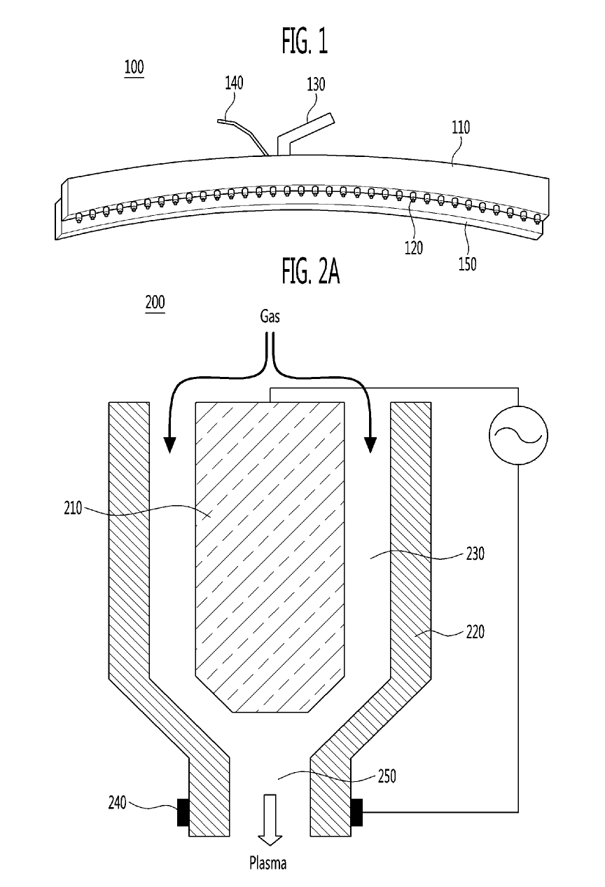

FIG. 1 is a schematic perspective view of a plasma surface treatment apparatus according to an exemplary embodiment of the present invention.

Referring to FIG. 1, a plasma surface treatment apparatus 100 according to an exemplary embodiment of the present invention includes a frame 110 for plasma generation units, a plurality of plasma generation units 120 arranged in an array at the lower edge of the frame 110, a gas supply hole 130 installed on one side of the upper edge of the frame 110 and supplying a gas to the plurality of plasma generation units 120, and a power supply unit 140 installed on the other side of the upper edge of the frame 110 and supplying power to the plurality of plasma generation units 120.

The frame 110 for plasma generation units has no limit on size and material, and a material which is general in the art can be used. The frame 110 for plasma generation units may further include an auxiliary frame 150 which is connected to the frame 110 to space the respective plasma generation units 120 apart from a surface and support them.

The plurality of plasma generation units 120 arranged in an array at the lower edge of the frame 110 may have a nozzle shape or a needle shape.

Also, the plurality of arranged plasma generation units 120 may have variable resistors (not shown) capable of adjusting the plasma generation voltages of the respective plasma generation units 120.

The plasma generation units 120 are arranged in a line at regular intervals but may be arranged in another shape as occasion demands. The number and intervals of the plasma generation units 120 are not limited, and may vary according to the size and degree of a target to be surface-treated.

The gas supply hole 130 may be installed on one side of the upper edge of the frame 110 and supply a gas to the plurality of plasma generation units 120. The supplied gas is for plasma generation and reaction, and a single gas or several kinds of gases mixed at a predetermined ratio may be supplied. For example, helium (He), neon (Ne), argon (Ar), nitrogen (N₂), oxygen (O₂), hydrogen (H₂), tetrafluoromethane (CF₄), methane (CH₄), etc. may be used as the gas for plasma generation and reaction. Also, the gas supply hole 130 may include at least one gas adjustment hole (not shown) capable of adjusting gas flow.

The power supply unit 140 is installed on the other side of the upper edge of the frame 110, and alternating current (AC) power having a sine waveform, square waveform, or pulse waveform and a frequency may be supplied from several Hz to tens of MHz.

When the gas is supplied to the respective plasma generation units 120 through the gas supply hole 130 and the power is supplied through the power supply unit 140, the respective plasma generation units 120 generate and spray plasma to the surface of an object, thereby treating the surface.

Meanwhile, in the brush type plasma surface treatment apparatus 100, at least one controller (not shown) may control the plurality of plasma generation units 120 to spray plasma in sequence. When the plurality of plasma generation units 120 spray plasma in sequence, it is possible to obtain the same result as obtained by spraying plasma while moving the plasma generation units 120 without moving the plasma surface treatment apparatus 100. Also, the controller (not shown) may control the plurality of plasma generation units 120 to spray plasma at the same time. The variable resistors capable of adjusting respective plasma generation voltages may be configured so that plasma can be generated from the predetermined gas for a predetermined time.

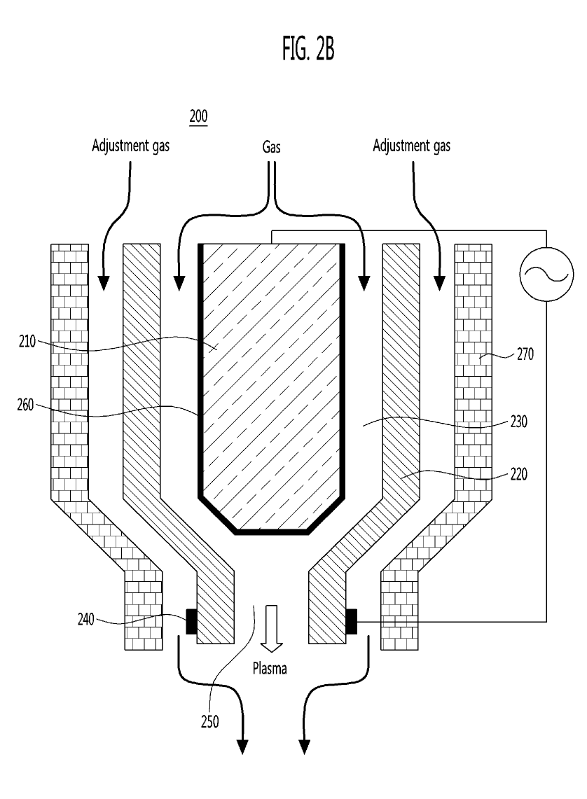

FIG. 2A is a cross-sectional view of a plasma generation unit according to an exemplary embodiment of the present invention, and FIG. 2B is a cross-sectional view of a plasma generation unit according to another exemplary embodiment of the present invention.

Referring to FIGS. 2A and 2B, a plasma generation unit 200 includes a first electrode 210, a plasma generation chamber 220 containing the first electrode 210, a supply path 230 through which a gas for plasma generation and reaction is supplied between the first electrode 210 and the plasma generation chamber 220, a second electrode 240 formed on the outside of the plasma generation chamber 220, and a spray hole 250 from which plasma is sprayed.

The electrodes, chamber, etc. constituting the plasma generation unit 200 are not limited, and those general in the art can be used.

The gas for plasma generation and reaction is supplied through the supply path 230 between the first electrode 210 and the plasma generation chamber 220, and a single gas or several kinds of gases mixed at a predetermined ratio may be supplied. For example, helium (He), neon (Ne), argon (Ar), nitrogen (N₂), oxygen (O₂), hydrogen (H₂), tetrafluoromethane (CF₄), methane (CH₄), etc. or a mixture thereof may be used as the gas for plasma generation and reaction.

Power is supplied to the first electrode 210 and the second electrode 240, and the gas introduced into the plasma generation chamber 220 causes an electrical reaction, thereby generating plasma.

As shown in FIG. 2B, an insulating layer 260 may be formed on the surface of the first electrode 210 to prevent arc discharge, and an adjustment gas chamber 270 surrounding the plasma generation chamber 220 may be formed to introduce an adjustment gas, by which the shape and length of the plasma can be adjusted, to another supply path between the plasma generation chamber 220 and the adjustment gas chamber 270, thereby controlling the plasma. In other words, an adjustment gas such as air or nitrogen is introduced through the adjustment gas chamber 270 to adjust the plasma according to the pressure and flow of the adjustment gas. Here, when contact with external air is minimized and the pressure of the adjustment gas introduced through the adjustment gas chamber 270 is increased, the adjustment gas is transformed into a fluid having one shape, and the direction and size of the plasma generated can be adjusted by the fluid having a shape. Also, when a reaction gas is introduced through the supply path 230, a gas having a lower density, a higher density, or the same density than/as the reaction gas may be introduced between the plasma generation chamber 220 and the adjustment gas chamber 270, thereby adjusting the shape of the plasma. In other words, when a gas having a lower density than the reaction gas is introduced into the adjustment gas chamber 270, the plasma is concentrated at the center.

The spray hole 250 from which the plasma is sprayed has a thin and long slit shape, and sprays the plasma to the outside.

According to properties of the plasma generated by the plasma generation unit 200, the surface of an object is modified to be hydrophilic or hydrophobic, which will be described in further detail below.

When argon (Ar) or helium (He) gas and CF₄ or CH₄ gas are supplied to the plasma generation unit 200, CH₂ and CH₃ groups are formed on the surface to be treated, and the surface becomes hydrophobic. For example, when the surface of a car window is modified to be hydrophobic by plasma surface treatment, it cannot easily combine with water molecules. Thus, when raindrops fall to the car window, they run down the window immediately. As a result, it is possible to clear the driver's view without using wipers, which are brush type surface treatment devices, and fatigue of his/her eyes can be relieved.

In other words, the surface of an object can be modified to be hydrophobic using the plasma generated by the plasma generation unit 200. Thus, it is possible to prevent dust or foreign substances from being absorbed to the surface of the object, thereby keeping the surface of the object clean.

Meanwhile, a gas introduced into the plasma generation unit 200 may be appropriately selected to modify the surface of an object to be hydrophilic. For example, when an OH group is formed on the surface of an object, the surface of the object becomes hydrophilic, that is, easily combines with water molecules, so that foreign substances can be easily absorbed to the surface. Thus, it is possible to easily deposit a foreign substance on the surface of the object, collect dust on the surface of the object, and form a water layer having a predetermined thickness. In other words, when the above-mentioned treatment is performed on glass, water runs down the glass in the form of a uniform layer. Thus, light is refracted not in a random direction but in a predetermined direction, thereby clearing the view.

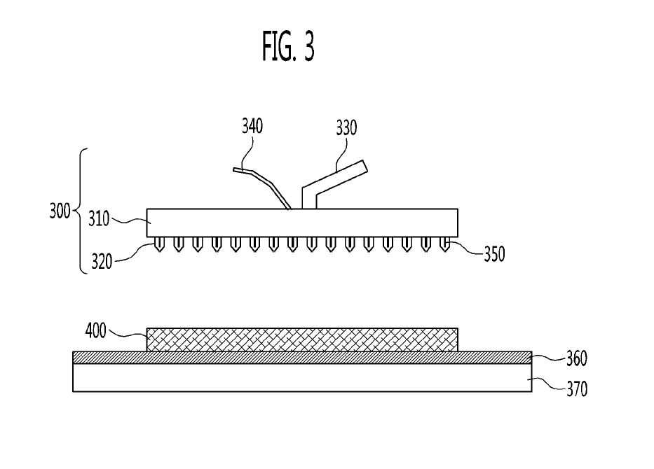

FIG. 3 illustrates a plasma surface treatment apparatus according to an exemplary embodiment of the present invention used to treat the surface of a dye-sensitized solar cell (DSSC) before dye absorption.

Referring to FIG. 3, an automated plasma surface treatment apparatus 300 for facilitating dye absorption performs surface treatment to form a hydrophilic surface using plasma before dye absorption so that dye can be easily absorbed to the surface thereafter.

The plasma surface treatment apparatus 300 includes a frame 310, a plurality of plasma generation units 320 arranged in an array on the frame 310 and spraying plasma, a gas injection hole 330 through which a gas for plasma generation and reaction is introduced, a power supply unit 340, and first electrodes 350 contained in plasma generation chambers of the plurality of plasma generation units 320. Also, a second electrode 360 is disposed on an insulating body 370 and under a DSSC 400, which is the target of the plasma surface treatment.

As external power is supplied to the first electrodes 350 and the second electrode 360, the plasma surface treatment apparatus 300 sprays plasma to the surface of the DSSC 400, and the surface of the DSSC 400 is modified so that dye can be easily absorbed to the surface.

The plasma surface treatment apparatus 300 is installed on a transfer unit (not shown) and moved, and thus plasma can be uniformly sprayed to the surface of the DSSC 400.

As described above, the brush type plasma surface treatment apparatus having a plurality of plasma generation units arranged in an array according to an exemplary embodiment of the present invention can not only keep a surface clean, but can also spray plasma to modify the surface of an object to be hydrophobic and prevent dust or foreign substances from being absorbed to the surface of the object, or modify the surface of the object to be hydrophilic and facilitate deposition of another substance on the surface.

Also, the brush type plasma surface treatment apparatus according to an exemplary embodiment of the present invention can efficiently spray plasma by controlling the plurality of plasma generation units arranged in an array.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A brush type plasma surface treatment apparatus, comprising:
a frame for plasma generation units;
a plurality of plasma generation units arranged in an array at a lower edge of the frame;
a gas supply hole installed on one side of an upper edge of the frame, and supplying a gas to the plurality of plasma generation units; and
a power supply unit installed on the other side of the upper edge of the frame, and supplying power to the plurality of plasma generation units.

2. The brush type plasma surface treatment apparatus of claim 1, wherein the plasma generation units have a nozzle shape or a needle shape.

3. The brush type plasma surface treatment apparatus of claim 1, wherein the power supply unit supplies the power from an external direct current (DC) power supply or an external alternating current (AC) power supply to the respective plasma generation units.

4. The brush type plasma surface treatment apparatus of claim 1, wherein the frame for plasma generation units includes an auxiliary frame connected to the frame to space the respective plasma generation units apart from a surface and support the plasma generation units.

5. The brush type plasma surface treatment apparatus of claim 1, further comprising at least one controller for controlling the plasma generation units to spray plasma.

6. The brush type plasma surface treatment apparatus of claim 1, wherein each of the plasma generation units includes a variable resistor to uniformly generate plasma.

7. The brush type plasma surface treatment apparatus of claim 1, wherein each of the plasma generation units includes:
a first electrode for supplying the power;
a plasma chamber containing the first electrode;
a supply path for a gas for plasma generation and reaction between the first electrode and the plasma chamber;
a second electrode attached to an outside of the plasma chamber and supplying the power; and
a slit-shaped spray hole for spraying plasma generated in the plasma chamber to the outside.

8. The brush type plasma surface treatment apparatus of claim 7, wherein the plasma generation unit further includes an insulating layer on the first electrode.

9. The brush type plasma surface treatment apparatus of claim 7, wherein the plasma generation unit further includes an adjustment gas chamber for introducing an adjustment gas for adjusting the plasma.
